(19) United States
(12) Patent Application Publication
(10) Pub. No.: US 2007/0112506 A1
(43) Pub. Date: May 17, 2007

(54) Navigation positional information providing system in internet website

(75) Inventors: Doo-Yeol Kim, Ichon-si (KR); Jae-Gyu Yoon, Ichon-si (KR)

Correspondence Address: STAAS & HALSEY LLP, SUITE 700, 1201 NEW YORK AVENUE, N.W., WASHINGTON, DC, 20005, US

(73) Assignee: Hyundai Autonet Co., Ltd., Ichon-si (KR)

(21) Appl. No.: 11/598,136

(22) Filed: Nov. 13, 2006

(30) Foreign Application Priority Data
Nov. 11, 2005 (KR) 10-2005-0108004

(51) Int. Cl. G01C 21/00

(52) U.S. Cl. 701/201; 701/211

(57) ABSTRACT

The present invention relates to a website service for a navigation user, and more particularly to a navigation positional information providing system in an Internet website wherein it informs a navigation user of the operation of a website, off-line positional information, and so on within websites, such as home pages and advertising sites. The present invention also provides a service that directly provides a user with positional information about an off-line way within a website through navigation. Furthermore, the present invention provides a web service system that provides positional information about a point designated within a website to a navigation apparatus that allows for wireless Internet communication when a user wants the positional information. The present invention also provides a navigation system operating in conjunction with website information, with which the positional information received from the web service system is automatically registered and in which a navigation apparatus provides a user with route information using the positional information.

### CROSS-REFERENCE TO RELATED APPLICATION

This application claims the benefit of Korean Application No. 10-2005-0108004 filed Nov. 11, 2005, in the Korean Intellectual Property Office, the disclosure of which is incorporated herein by reference.

### BACKGROUND OF THE INVENTION

1. Field of the Invention

The present invention relates, in general, to a website service for a navigation user, and more particularly to a navigation positional information providing system in an Internet website wherein it informs a navigation user of the operation of a website, off-line positional information, and so on within websites, such as home pages and advertising sites.

2. Description of the Related Art

In general, the term “navigation system” may refer to a system that allows a user to easily find a desired location using GPS information (i.e., positional information) in mapped geographical information.

In this navigation apparatus, the shortest distance is calculated based on the map database according to a starting location and a destination location in order to guide a route.

In general, in order to set a destination location, a navigation user inputs the name of a place, a firm name, a lot number and/or the like so as to search the map database for navigation data.

In this navigation method, however, a desired name of a place, a desired firm name, and/or a desired lot number must be registered with the navigation data in order to set the destination location. Furthermore, the navigation operation must be prepared to operate.

A user may visit lots of websites through the Internet.

The user finds information, such as “destination outline map” within a website, inputs information of a corresponding area to a navigation apparatus, and is then provided with a corresponding route.

For example, a user may visit a home page of “**corporation” (i.e., his client), confirm an outline map of “**corporation” in order to visit the company, input positional information of the navigation apparatus, and set a destination location.

In this case, “**corporation” is a point that has not been registered with the navigation apparatus.

That is, the user may find necessary information from the outline map within the home page without an address or additional information, take notes of the information, set a destination location by inputting the information to the navigation, and receive search information up to the destination location.

In general, when information about a desired destination location is short, a user must search the Internet for corresponding information, take notes of the searched information, and input the information to the navigation during an actual operation so as to receive route information up to the destination location. However, it makes a user perform the navigation task twice.

### SUMMARY OF THE INVENTION

Additional aspects and/or advantages of the invention will be set forth in part in the description which follows and, in part, will be apparent from the description, or may be learned by practice of the invention.

Accordingly, the present invention has been made in view of the above problems occurring in the prior art, and it is an object of the present invention to provide a service that directly provides a user with positional information about an off-line way within a website through navigation.

An aspect of the present invention is to provide a web service system that provides positional information about a point designated within a website to a navigation apparatus that allows for wireless Internet communication when a user wants the positional information.

Another aspect of the present invention is to provide a navigation system operating in conjunction with website information, with which the positional information received from the web service system is automatically registered and in which a navigation apparatus provides a user with route information using the positional information based on the positional information.

According to an aspect of the present invention, there is provided a navigation positional information providing system in an Internet website, including a website management system for providing positional information, which will be automatically registered with a navigation, at the request of a user, and a navigation system includes a wireless Internet communication means for receiving positional information that will be automatically registered from the website management system.

The website management system includes an Internet server for providing a menu for providing an accessed user with Internet information and servicing navigation-provided positional information of a point to be guided and a process of transmitting the navigation-provided positional information included in the menu to the user's navigation system when the user selects the menu and requests positional information.

The navigation system includes a wireless communication means for performing a wireless Internet, and an Internet point registration processor for providing a process of performing the wireless Internet, confirming automatic location registration information transmitted from the website management system, of the information transmitted via the Internet, and registering the location of a point with a geographical information storage means.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing the construction of a navigation positional information providing system according to an embodiment of the present invention; and

FIG. 2 illustrates an example of a location registration menu for a navigation user, which is displayed on an Internet screen according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

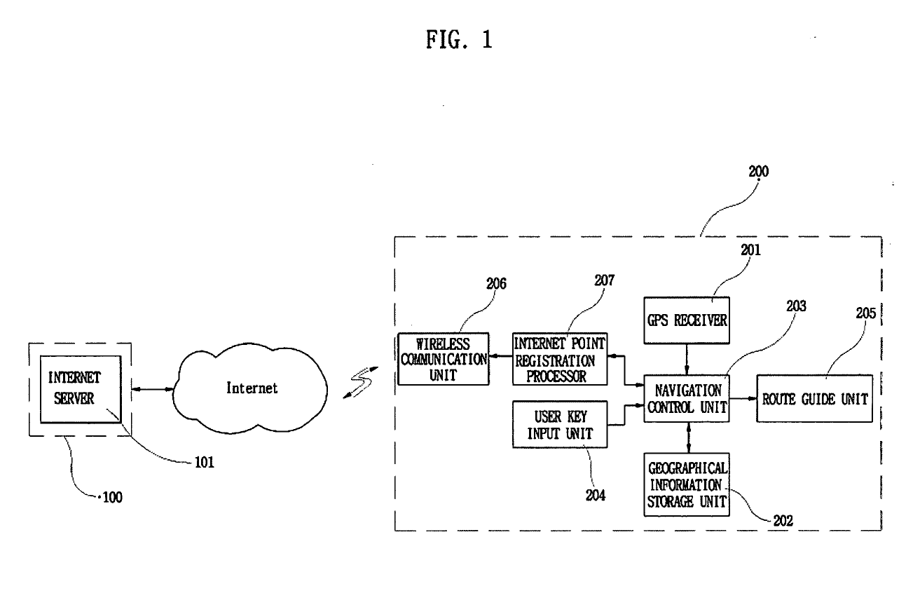

FIG. 1 is a block diagram showing the construction of a navigation positional information providing system according to an embodiment of the present invention.

Referring to FIG. 1, the navigation positional information providing system according to an embodiment of the present invention includes a website management system 100 that provides positional information, which will be automatically registered with a navigation, at the request of a user, and a navigation system 200 that receives positional information that will be automatically registered from the website management system 100 and includes a wireless Internet communication means.

The website management system 100 includes an Internet server 101. The Internet server 101 provides a menu (contents) to provide an accessed user with Internet information and servicing navigation-provided positional information of a point to be guided, and a process of transmitting the navigation-provided positional information included in the menu to the user's navigation system when the user selects the menu and requests positional information.

The navigation system 200 includes a GPS receiver 201, a geographical information storage unit 202, a navigation control unit 203, a user key input unit 204, a route guide unit 205, a wireless communication unit 206 and an Internet point registration processor 207. The GPS receiver 201 receives a signal from a GPS satellite and detects a vehicle's self-position coordinates based on the signal. The geographical information storage unit 202 stores geographical information to be provided to a user with respect to the positional coordinates. The navigation control unit 203 provides guide information according to a user's search route and traveling route through the route guide unit 205 based on the geographical information of the geographical information storage unit 202 with respect to a current location of the vehicle, which has been recognized by the GPS receiver 201. The wireless communication unit 206 performs a wireless Internet. The Internet point registration processor 207 provides a process of performing a wireless Internet, confirming automatic location registration information transmitted from the website management system, of information transmitted via the Internet, and registering the location of a point with the geographical information storage unit 202.

The navigation positional information providing system constructed above according to the present invention configures a menu including positional registration information for a navigation user in locations such as an outline map and an address.

The menu is presented on the screen as an icon via the Internet. The menu is written as an Internet document type (HTML) so that a user can select the menu to receive positional information. The menu also includes link information about positional information for navigation, which will be provided to a navigation user, and positional information for navigation, which is stored in a server when a user selects the menu. The menu is transmitted to a user's navigation.

The menu is displayed together with a sketch map, such as “a map of how to get there” within a website or the location of each point.

The positional information for navigation includes ID information for informing navigation positional information for automatic location registration, a registration point name and point coordinates. The positional information for navigation may further include an address, a telephone number, a home pages address (URL) and/or the like.

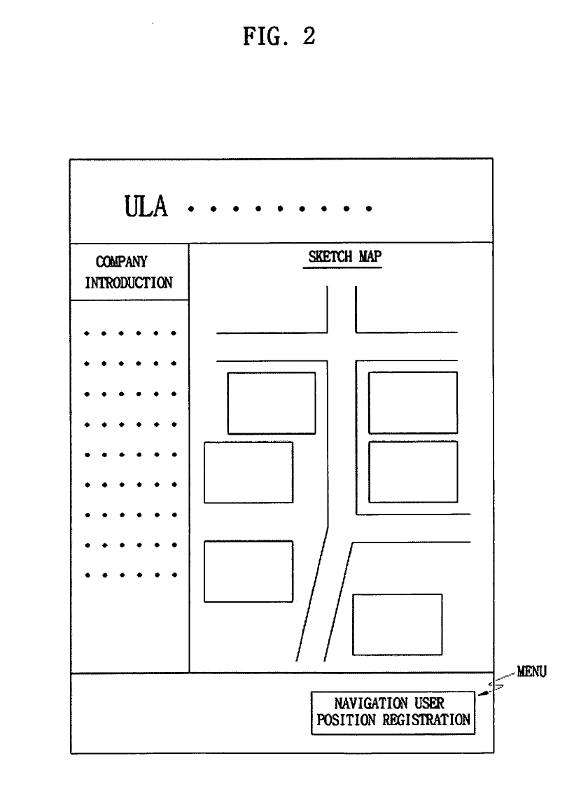

FIG. 2 illustrates an example of a location registration menu for a navigation user, which is displayed on an Internet screen according to an embodiment of the present invention.

The operation of the present invention will be described below.

The Internet point registration processor 207 of the navigation system 200 provides a wireless Internet through the wireless communication unit 206 at the request of a user.

The user can gain access to the Internet server 101 of a corresponding website and receive information. The user can also find an outline map in order to confirm an off-line point of a website.

The Internet server 101 displays an outline map screen including a navigation user location registration menu, as shown in FIG. 2.

If the user selects the navigation user location registration menu, the Internet server 101 transmits positional information for navigation, which is linked to the navigation user location registration menu, to the navigation system 200 of a corresponding user.

The navigation system recognizes ID information included in the positional information for the navigation, of the received information and recognizes that it is positional registration information for navigation. The navigation system then stores the received positional information for navigation in the geographical information storage unit 202.

Thereafter, the navigation control unit 103 can display and select the positional information for navigation, which has been registered with the geographical information storage unit 202, on a map according to geographical information.

Furthermore, it is possible to find a destination location according to the name of a point included in the positional information for navigation, find a route based on selection, telephone using a telephone number, link to a home page address and so on.

According to an aspect of the present invention, a navigation user can be provided with not only positional coordinates of a point, which will be known by a home page, but also information, such as a home page address, a telephone number and an address for operating the home page. Accordingly, the present invention is advantageous in advertising.

Furthermore, a navigation user can easily receive coordinate information about a desired point and can use the received coordinate information for search and route search.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A system for providing a navigation positional information in an Internet website, comprising:
a website management system to provide positional information, which will be automatically registered with a navigation, at the request of a user; and
a navigation system including a wireless Internet communication unit to receive positional information that will be automatically registered from the website management system.

2. The system of claim 1, wherein the website management system comprises an Internet server to provide a menu for providing an accessed user with Internet information and servicing navigation-provided positional information of a point to be guided, and a process of transmitting the navigation-provided positional information included in the menu to the user's navigation system when the user selects the menu and requests positional information.

3. The system of claim 1, wherein the navigation system comprises a wireless communication part to perform a wireless Internet, and an Internet point registration processor to provide a process of performing the wireless Internet, to confirm automatic location registration information transmitted from the website management system, of the information transmitted via the Internet, and to register the location of a point with a geographical information storage unit.

4. The navigation positional information providing system of claim 2, wherein the navigation-provided positional information includes ID information, a registration point name, and point coordinates.

5. The navigation positional information providing system of claim 4, wherein the navigation-provided positional information further includes an address, a telephone number, and/ or a home page address URL.

6. The method for a navigation positional information in an Internet website; the method comprising:
selecting user location registration menu of navigation;
receiving positional information from an Internet server; and storing the received information.

7. The method of claim 6, wherein the received positional information is an address, a telephone number, and/or a home page address.
